(19) United States
(12) Patent Application Publication
(10) Pub. No.: US 2012/0240931 A1
(43) Pub. Date: Sep. 27, 2012

(54) BREATHING APPARATUS

(76) Inventor: Henry Graham Cornelius Shelford, London (GB)

(21) Appl. No.: 13/513,493

(22) PCT Filed: Dec. 3, 2010
(86) PCT No.: PCT/GB2010/002223

§ 371 Date: Jun. 1, 2012

(30) Foreign Application Priority Data
Dec. 3, 2009 (GB) 0921222.6

(51) Int. Cl. A62B 7/02; A62B 18/02

(52) U.S. Cl. 128/204.18

(57) ABSTRACT

Breathing apparatus (10) for high altitude climbing is provided and comprises: a compressor (30) for generating compressed air; means (50) for delivering air at approximately standard atmospheric pressure to a climber; and a power source (20) for powering the compressor.

The present invention relates generally to an improved breathing apparatus and particularly to a breathing apparatus for high altitude climbing.

Climbing at high altitudes is made difficult because of the lack of air, and therefore oxygen, at normal pressure. Pressure varies smoothly from the Earth's surface to the top of the Mesosphere, with pressure decreasing with increasing elevation. The standard atmosphere (symbol: atm) is a unit of pressure defined as being equal to 101325 Pascals. In general terms for every 1,000 feet ascending the atmospheric pressure decreases by 4%. This means that, for example, at the summit of Everest the air has approximately one third of the air pressure of that at sea level.

It is known for high altitude climbers to add oxygen from a tank to supplement the lower air pressure at high altitudes. However, the use of oxygen stored in tanks is limited by the amount of tanks that can be transported on an expedition. Moreover, oxygen delivered at high concentrations is poisonous and accordingly additional equipment and close supervision is required to manage the release of oxygen from the tank.

The present invention seeks to address the problems with known apparatus used for aiding respiration at high altitudes.

According to a first aspect of the present invention there is provided breathing apparatus for high altitude climbing comprising: a compressor for generating compressed air; means for delivering air at approximately standard atmospheric pressure to a climber; and a power source for powering the compressor.

The solution provided by the present invention is therefore to “normalise” the air pressure and deliver air at approximately standard atmospheric pressure directly to the climber.

The apparatus may further comprise a storage tank for storing compressed air. This means that, for example, the compressor may be used periodically to charge a tank of air; thereafter air is delivered from the tank to the climber. This is an alternative to delivering air directly from the compressor to the climber.

The power source may conveniently comprise a battery. Lithium batteries are seen as advantageous because they can retain charge even as temperature decreases.

The means for delivering air to the climber may conveniently comprise a mask, such as a mask for the oral and nasal area which allows sealed respiration of oxygen.

The meaning of the term “approximately standard atmospheric pressure” is intended to encompass air within a range of pressures which is suitable for prolonged respiration. With standard atmospheric pressure being approximately one atmosphere, the breathing apparatus of the present invention may supply air having a pressure in the range of 0.5 to 1.5 atmospheres, preferably 0.8 to 1.2 atmospheres and more preferably 0.9 to 1.1 atmospheres.

According to a second aspect of the present invention there is provided a high altitude climbing breathing apparatus kit comprising: a compressor for generating compressed air; and means for delivering air from the tank to a climber at approximately standard atmospheric pressure; and a power source for powering the compressor.

The kit may further comprise a storage tank for periodically receiving air from the compressor and subsequent delivery to the climber on demand.

According to a further aspect of the present invention there is provided a method of providing air at approximately standard atmospheric pressure for a high altitude climber, comprising the steps of: using a compressor to compress air; and delivering air from the compressor to a climber at approximately standard atmospheric pressure.

The method may further comprise the steps of periodically charging a storage tank with compressed air from the compressor and delivering the air to the climber from the tank.

The present invention will now be more particularly described, by way of example, with reference to the accompanying drawings, in which:

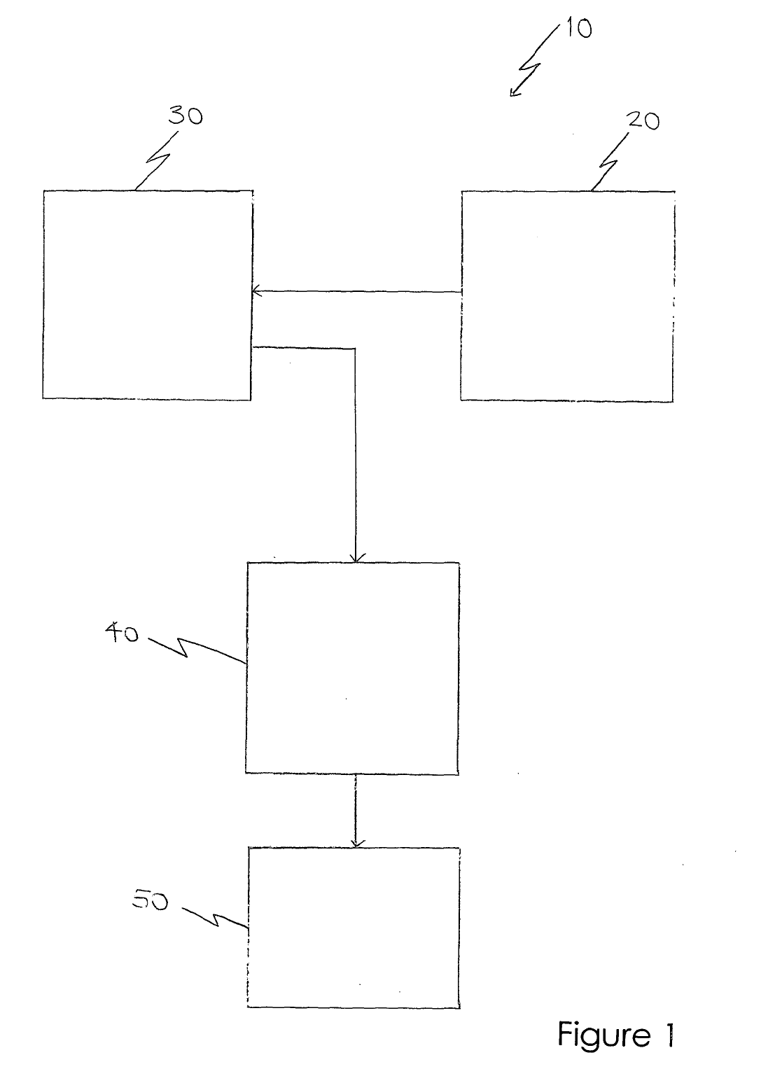

FIG. 1 is a schematic representation of breathing apparatus formed according to a first embodiment of the present invention;

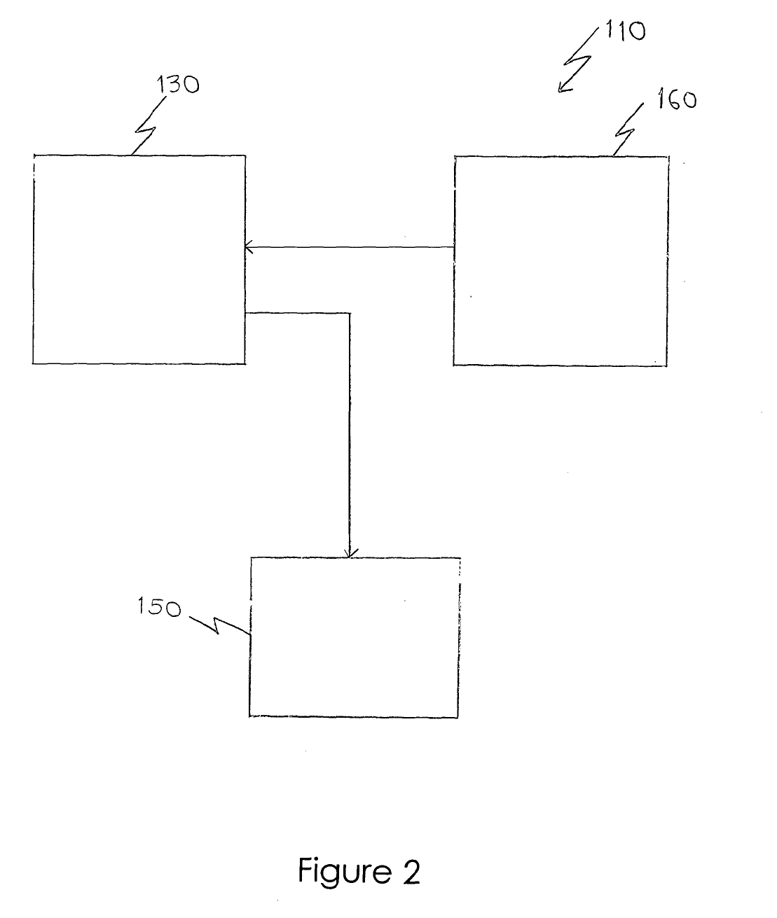

FIG. 2 is a schematic representation of breathing apparatus formed according to an alternative embodiment of the present invention; and

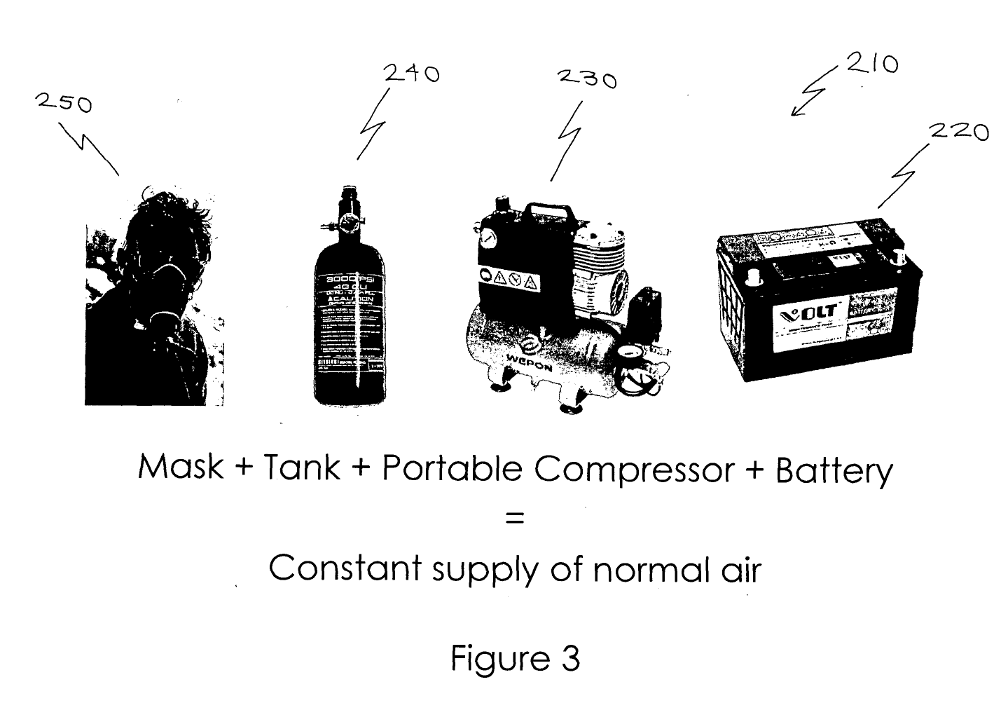

FIG. 3 is a schematic representation of breathing apparatus formed according to an alternative embodiment of the present invention.

Referring first to FIG. 1 there is shown breathing apparatus generally indicated 10. In brief, the apparatus 10 comprises: a battery 20; a compressor 30; a storage tank 40; and a respirator mask 50.

The compressor 30 is used periodically on a high altitude climbing expedition to receive low pressure atmospheric air and compress it for delivery to the storage tank 40. The air is compressed so that it is at approximately standard atmospheric air pressure. Subsequently the air is delivered from the tank 40 to the respirator mask 50 so that the climber can breathe normally.

In other embodiments (not shown) the air is compressed to above standard atmospheric pressure levels and stored in the tank. Subsequently air is delivered from the tank and modified to approximately standard atmospheric air pressure by a valve arrangement for delivery to the mask 50.

In this embodiment the compressor is selected so as to be easily portable and is powered by a lithium battery 20. Other forms of power source are possible, for example including solar or wind power generators which may be selected on the basis of the conditions anticipated on an expedition.

Referring now to FIG. 2 there is shown breathing apparatus generally indicated 110 formed according to an alternative embodiment.

In this embodiment a compressor 130 is again used to compress high altitude, low pressure atmospheric air. In this embodiment the air from the compressor 130 is supplied directly to the mask 150 at approximately standard atmospheric air pressure.

In this embodiment the compressor 130 is powered by a mechanical generator 160.

Referring now to FIG. 3 there is shown a high altitude breathing apparatus system generally indicated 210.

The system 210 comprises: a mask 250; an air tank 240; a portable compressor 230; and a battery 220.

The system 210 works in a very similar way to the apparatus 10, 110 of FIGS. 1 and 2 in that the compressor, powered by the battery, compresses atmospheric air and feeds it either directly to the mask or to the tank for storage and onward delivery to the mask.

1. Breathing apparatus for high altitude climbing comprising:
a compressor for generating compressed air;
means for delivering the compressed air at approximately standard atmospheric pressure to a climber; and
a power source for powering the compressor.

2. Apparatus as claimed in claim 1, further comprising a storage tank for storing the compressed air.

3. Apparatus as claimed in claim 1, in which the power source comprises a battery.

4. Apparatus as claimed in claim 3, in which the battery comprises a lithium battery.

5. Apparatus as claimed in claim 1, in which the means for delivering the compressed air comprise a mask.

6. A high altitude climbing breathing apparatus kit comprising:
a compressor for generating compressed air;
a storage tank for storing the compressed air;
means for delivering the compressed air from the storage tank to a climber at approximately standard atmospheric pressure; and
a power source for powering the compressor.

7. A kit as claimed in claim 6, wherein the storage tank is configured for periodically receiving the compressed air from the compressor and subsequent delivery to the climber on demand.

8. A method of providing air at approximately standard atmospheric pressure for a high altitude climber, comprising the steps of:
using a compressor to compress air;
delivering the air from a storage tank to a climber at approximately standard atmospheric pressure.

9. A method as claimed in claim 8, further comprising the step of periodically charging the storage tank with the compressed air from the compressor.

10. (canceled)

11. (canceled)

12. (canceled)
